(19) United States
(12) Patent Application Publication
(10) Pub. No.: US 2024/0416433 A1
(43) Pub. Date: Dec. 19, 2024

(54) Drill bit with improved removal of the drill core

(71) Applicant: Hilti Aktiengesellschaft, Schaan (LI)

(72) Inventors: Marcel SONDEREGGER, Balgach (CH); József SZABÓ; Alexander GRETHER, Güterstrasse 10 (CH); Andreas Oliver SCHLAG, Sennwald (CH); Cliff TOLDO, Vaduz (LI); Matthaeus HOOP, Eschen (LI); Jens STRACKE, Feldkirch (AT)

(21) Appl. No.: 18/698,313

(22) PCT Filed: Sep. 28, 2022
(86) PCT No.: PCT/EP2022/076895

§ 371 Date: Apr. 3, 2024

(30) Foreign Application Priority Data
Oct. 11, 2021 (EP) 21201901.2

(51) Int. Cl. B23B 51/04

(52) U.S. Cl. CPC B23B 51/04; B23B 2265/08

(57) ABSTRACT

Drill bit (20) including a drilling shaft and a cutting portion having a first drilling segment (23-1) and a second drilling segment (23-2). The first drilling segment (23-1) has a first inner lateral surface (28-1) with a first inner distance (B₁(φ), h)), and the second drilling segment (23-2) has a second inner lateral surface (28-2) with a second inner distance (B₂(φ, h)) from the longitudinal axis (24) of the drilling shaft. The first inner lateral surface (28-1) is formed as a portion of a first inner cone (34-1) which tapers in the direction of a first upper side (32-1) opposite to the underside (31-1) of the first drilling segment (23-1).

### TECHNICAL FIELD

The present invention relates to a drill bit.

### BACKGROUND

In the case of diamond tools which are designed as drill bits for core drilling, a distinction is made between ring drill bits having a closed ring segment and segmented drill bits having a plurality of drilling segments.

Segmented drill bits comprise a drilling shaft having a shank and a cutting portion having a plurality of drilling segments. The drill bits are fastened in the tool fitting of a core drilling device via the shank and, during the drilling operation, are driven by the core drilling device about an axis of rotation which runs coaxially to the longitudinal axis of the drilling shaft. The drilling shaft has a cylinder with a cylinder axis which defines the longitudinal axis of the drilling shaft. The drilling segments have an outer lateral surface and an inner lateral surface, wherein the inner lateral surface is formed as a portion of a cylinder and has a constant inner distance from the longitudinal axis in a plane perpendicular to the longitudinal axis.

When drilling a substrate, for example a wall, a concrete wall or a concrete floor, a drill core is obtained in the interior of the drill bit and has to be removed from the drill bit after drilling, with it being possible that problems may occur and the drill core is jammed in the interior. Particular problems are provided by fragments which can break out of the drill core and jam between the drill bit and drill core.

Segmented drill bits are distinguished into drill bits having an exchangeable cutting portion, which is releasably connected to the drilling shaft, and drill bits having a fixed cutting portion. Drill bits having an exchangeable cutting portion have easier removal of the drill core than drill bits having a fixed cutting portion, since the cutting portion can be removed in order to remove the drill core.

### SUMMARY OF THE INVENTION

An object of the present invention is to develop a drill bit having a plurality of drilling segments in which the risk of jamming drill cores is reduced even for small drill bit diameters. In addition, it is intended for the removal of a jamming drill core to be simplified.

The present invention provides a drill comprising:
a drilling shaft (21; 41; 61) which has a cylinder (25; 45; 65) with a longitudinal axis (24; 44; 64), wherein the cylinder (25; 45; 65) has, in a plane (26; 46) perpendicular to the longitudinal axis (24; 44; 64), an outside diameter (d_{A}), an inside diameter (d_{I}) and a shaft width (b), and
a plurality of drilling segments (23-1, 23-2; 43-1, 43-2, 43-3; 63-1, 63-2, 63-3) which are spaced apart from one another in a circumferential direction (@) and fastened by an underside (31-1, 31-2; 51-1, 51-2, 51-3) to the drilling shaft (21; 41; 61), wherein the plurality of drilling segments (23-1, 23-2; 43-1, 43-2, 43-3; 63-1, 63-2, 63-3) comprise a first drilling segment (23-1; 43-1; 63-1) with a first inner lateral surface (28-1; 48-1; 68-1) which has a first inner distance (B₁(φ, h)) from the longitudinal axis (24; 44; 64) perpendicular to the longitudinal axis (24; 44; 64), and a second drilling segment (23-2; 43-2; 63-2) with a second inner lateral surface (28-2; 48-2; 68-2) which has a second inner distance (B₂(φ, h)) from the longitudinal axis (24; 44; 64) perpendicular to the longitudinal axis (24; 44; 64).

According to the invention, the drill bit is characterized in that the first inner lateral surface of the first drilling segment is formed as a portion of a first inner cone which tapers in the direction of a first upper side opposite to the underside of the first drilling segment.

The drill bit according to the invention comprises a first drilling segment with a first inner lateral surface which has a first inner distance from the longitudinal axis, and a second drilling segment which has a second inner distance from the longitudinal axis, wherein the first inner lateral surface is conical. The formation of the first inner lateral surface as a portion of an inner cone has the advantage that the contact surface between the drilling segment and the drill core is reduced.

Preferably, the first inner cone has a first base surface which differs from a circular shape, and the first inner distance varies in the circumferential direction over the circumference of the first drilling segment. The variation of the first inner distance in the circumferential direction allows the contact surface between the drilling segment and the drill core to be further reduced. Particularly preferably, the first base surface has a first elliptical shape; the elliptical shape is particularly suitable as a noncircular first base surface.

Particularly preferably, the first inner distance varies between a first maximum value and a first minimum value and has precisely one first absolute minimum value over the circumference of the first drilling segment. The distribution of the first maximum values and of the first absolute minimum value over the circumference of the first drilling segment allows the production of a first drilling segment having a small contact surface with respect to the drill core. The first drilling segment can be in contact with the drill core only in the region of the first absolute minimum value, with all remaining regions of the first inner lateral surface having a gap with respect to the drill core.

Preferably, the second inner lateral surface of the second drilling segment is formed as a portion of a second inner cone which tapers in the direction of a second upper side opposite to the underside of the second drilling segment. The formation of the second inner lateral surface as a portion of an inner cone with a second base surface has the advantage that the contact surface between the drilling segment and the drill core is reduced.

Particularly preferably, the second inner cone has a second base surface which differs from a circular shape, and the second inner distance varies in the circumferential direction over the circumference of the second drilling segment. The variation of the second inner distance in the circumferential direction allows the contact surface between the drilling segment and the drill core to be further reduced. Particularly preferably, the second base surface has a second elliptical shape; the elliptical shape is particularly suitable as a noncircular second base surface.

Particularly preferably, the second inner distance varies between a second maximum value and a second minimum value and has precisely one second absolute minimum value over the circumference of the second drilling segment. By virtue of the fact that the second drilling segment has precisely one second absolute minimum value over the circumference, the contact surface between the second drilling segment and the drill core is limited to the region of the second absolute minimum value. The second drilling segment has a contact surface with respect to the drill core only if the first absolute minimum value and second absolute minimum value correspond.

Preferably, the first drilling segment and second drilling segment are of identical design. Particularly preferably, the first drilling segment and second drilling segment are arranged in an equally distributed manner in the circumferential direction. A drill bit having two drilling segments which are identical within the production tolerances has uniform abrasive removal properties. The first absolute minimum value and second absolute minimum value are situated opposite one another in the circumferential direction and lead to a mirror-symmetrical design of the drill bit. The mirror-symmetrical design allows vibrations of the drill bit to be reduced during the drilling operation and the running smoothness of the drill bit to be improved.

In a further development, in addition to the first drilling segment and second drilling segment, the plurality of drilling segments comprise a third drilling segment with a third inner inner lateral surface which has a third inner distance from the longitudinal axis perpendicular to the longitudinal axis. With an increasing diameter of the drilling shaft, the number of drilling segments which are fastened to the drilling shaft increases.

Particularly preferably, the third inner lateral surface of the third drilling segment is formed as a portion of a third inner cone which tapers in the direction of a third upper side opposite to the underside of the third drilling segment. The formation of the third inner lateral surface as a portion of an inner cone with a third base surface has the advantage that the contact surface between the drilling segment and the drill core is reduced.

Particularly preferably, the third inner cone has a third base surface which differs from a circular shape, and the third inner distance varies in the circumferential direction over the circumference of the third drilling segment. The variation of the third inner distance in the circumferential direction allows the contact surface between the drilling segment and the drill core to be further reduced. Particularly preferably, the third base surface has a third elliptical shape; the elliptical shape is particularly suitable as a noncircular third base surface.

Particularly preferably, the third inner distance varies between a third maximum value and a third minimum value and has precisely one third absolute minimum value over the circumference of the third drilling segment. By virtue of the fact that the third drilling segment has precisely one third absolute minimum value over the circumference, the contact surface between the third drilling segment and the drill core is limited to the region of the third absolute minimum value. The third drilling segment has a contact surface with respect to the drill core only if the first absolute minimum value and third absolute minimum value correspond.

Preferably, the first drilling segment, second drilling segment and third drilling segment are of identical design. Particularly preferably, the first drilling segment, second drilling segment and third drilling segment are arranged in an equally distributed manner in the circumferential direction. A drill bit having three drilling segments which are identical within the production tolerances has uniform abrasive removal properties. The first absolute minimum value, second absolute minimum value and third absolute minimum value are arranged with an offset of about 120° in the circumferential direction and lead to a mirror-symmetrical design of the drill bit. The mirror-symmetrical design allows vibrations of the drill bit to be reduced during the drilling operation and the running smoothness of the drill bit to be improved.

### BRIEF DESCRIPTION OF THE DRAWINGS

Exemplary embodiments of the invention are described hereinafter with reference to the drawing. It is not necessarily intended for this to illustrate the exemplary embodiments to scale; rather, the drawing is produced in a schematic and/or slightly distorted form where this is useful for purposes of explanation. It should be taken into account here that various modifications and alterations relating to the form and detail of an embodiment may be undertaken without departing from the general concept of the invention. The general concept of the invention is not limited to the exact form or the detail of the preferred embodiment shown and described hereinafter or limited to subject matter that would be restricted compared with the subject matter claimed in the claims. For given dimensioning ranges, values within the stated limits should also be disclosed as limit values and should be able to be used and claimed as desired. For the sake of simplicity, the same reference signs are used hereinafter for identical or similar parts or parts having an identical or similar function.

In the drawing:

FIG. 1 shows a drill bit having a drilling shaft and two drilling segments which are fastened to the drilling shaft;

FIGS. 2A, B show a first embodiment of a drill bit according to the invention having a drilling shaft and two drilling segments in a three-dimensional view (FIG. 2A) and in a longitudinal section parallel to the longitudinal axis of the drilling shaft (FIG. 2B);

FIGS. 3A, B show the drill bit of FIG. 2A in a view of the upper side of the drilling segments (FIG. 3A) and the drilling segments in a longitudinal section parallel to the longitudinal axis of the drilling shaft (FIG. 3B);

FIGS. 4A, B show a second embodiment of a drill bit according to the invention having a drilling shaft and three drilling segments in a three-dimensional view (FIG. 4A) and in a longitudinal section parallel to the longitudinal axis of the drilling shaft (FIG. 4B);

FIGS. 5A, B show the drill bit of FIG. 4A in a view of the upper side of the drilling segments (FIG. 5A) and the drilling segments in a longitudinal section parallel to the longitudinal axis of the drilling shaft (FIG. 5B); and

FIG. 6 shows a third embodiment of a drill bit according to the invention having a drilling shaft and three drilling segments in a view of the upper side of the drilling segments.

### DETAILED DESCRIPTION

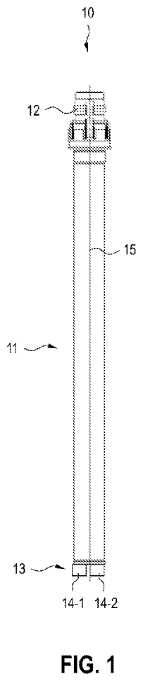

FIG. 1 shows a drill bit 10 which has a drilling shaft 11 having a shank 12 and a cutting portion 13 having a first drilling segment 14-1 and a second drilling segment 14-2. The drill bit 10 is fastened in the tool fitting of a core drilling device via the shank 12 and, during the drilling operation, is driven by the core drilling device about an axis of rotation which runs coaxially to the longitudinal axis 15 of the drilling shaft 11.

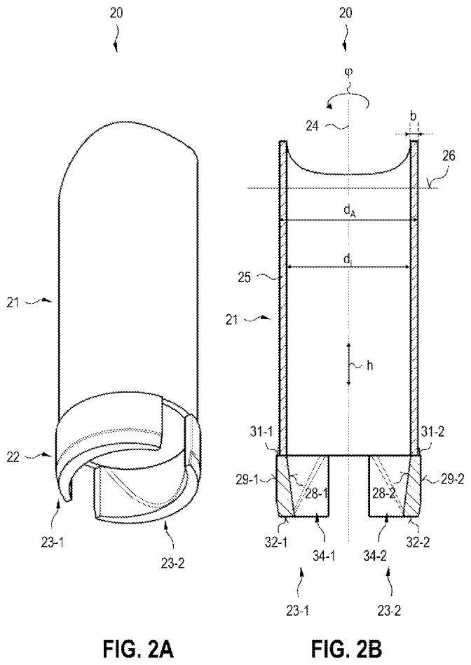

FIGS. 2A, B show a first embodiment of a drill bit 20 according to the invention which has a drilling shaft 21 and a cutting portion 22 having a first drilling segment 23-1 and a second drilling segment 23-2. In this case, FIG. 2A shows the drill bit 20 in a three-dimensional view and FIG. 2B shows the drill bit 20 in a longitudinal section parallel to the longitudinal axis 24 of the drilling shaft 21.

The drilling shaft 21 comprises a cylinder 25 which, in a plane 26 perpendicular to the cylinder axis, which defines the longitudinal axis 24 of the drilling shaft 21, has an outside diameter d_{A}, an inside diameter d_{I} and a shaft width b. In the exemplary embodiment, the inside diameter d_{I}, the outside diameter d_{A} and the shaft width b are constant both in a circumferential direction φ and in a height direction h. Alternatively, the inside diameter, the outside diameter and/or the shaft width can vary in the circumferential direction φ and/or the height direction h.

The first drilling segment 23-1 comprises a first inner lateral surface 28-1, a first outer lateral surface 29-1, a first underside 31-1 and a first upper side 32-1, and the second drilling segment 23-2 comprises a second inner lateral surface 28-2, a second outer lateral surface 29-2, a second underside 31-2 and a second upper side 32-2. Here, the first underside 31-1 of the first drilling segment 23-1 and the second underside 31-2 of the second drilling segment 23-2 are fastened to an end face of the drilling shaft 21.

The first inner lateral surface 28-1 of the first drilling segment 23-1 is formed as a portion of a first inner cone 34-1 which tapers in the direction of the first upper side 32-1 of the first drilling segment 23-1, and the second inner lateral surface 28-2 of the second drilling segment 23-2 is formed as a portion of a second inner cone 34-2 which tapers in the direction of the second upper side 32-2 of the second drilling segment 23-2.

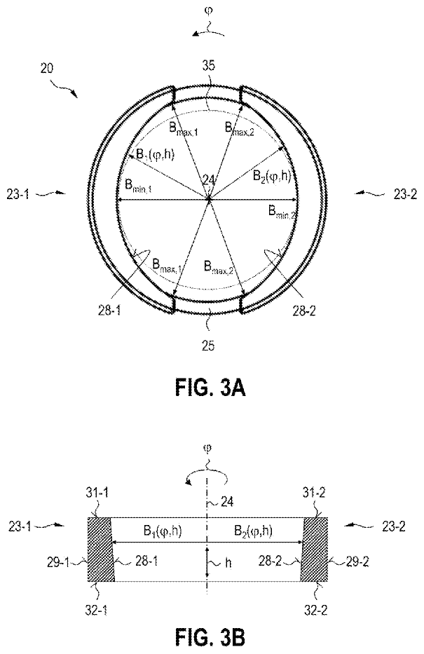

FIGS. 3A, B show the drill bit 20 according to the invention of FIG. 2A in a view of the upper side of the drilling segments 23-1, 23-2 (FIG. 3A) and the drilling segments 23-1, 23-2 in a longitudinal section parallel to the longitudinal axis 24 of the drilling shaft 21 (FIG. 3B).

The first inner lateral surface 28-1 has, in the plane 26 perpendicular to the longitudinal axis 24, a first inner distance B₁(φ, h) from the longitudinal axis 24. Here, the first inner distance B₁(φ, h) defines a first mathematical function which describes the profile of the first inner distance over the circumference and the height of the first drilling segment 23-1.

The first inner distance B₁(φ, h) varies between a first minimum value B_{min,1} and a first maximum value B_{max,1} in the circumferential direction φ over the circumference of the first drilling segment 23-1; the first inner distance B₁(φ, h) varies in the height direction h and decreases in the direction of the first upper side 32-1 of the first drilling segment 23-1. The first inner distance B₁(φ, h) has a further first maximum value B_{max,1}, wherein the first absolute minimum value B_{min,1} is arranged between the two first maximum values in the circumferential direction φ. The first inner distance B₁(φ, h) follows a strictly monotonic profile in the region of the first absolute minimum value B_{min,1} in the plane 26 perpendicular to the longitudinal axis 24.

The distribution of the first maximum values B_{max,1} and of the first absolute minimum value B_{min,1} over the circumference of the first drilling segment 23-1, the strictly monotonic profile of the first inner distance B₁(φ, h) in the region of the first absolute minimum value B_{min,1} and the variation of the first inner distance B₁(φ, h) in the height direction h allow the production of a first drilling segment 23-1 with a small contact surface with respect to the drill core 35. The first drilling segment 23-1 can be in contact with the drill core 35 only in the region of the first absolute minimum value B_{min,1}, with all remaining regions of the first inner lateral surface 23-1 having a gap with respect to the drill core 35.

The second inner lateral surface 28-2 has, in the plane 26 perpendicular to the longitudinal axis 24, a second inner distance B₂(φ, h) from the longitudinal axis 24. Here, the second inner distance B₂(φ, h) defines a second mathematical function which describes the profile of the second inner distance over the circumference and the height of the second drilling segment 23-2.

The second inner distance B₂(φ, h) varies between a second minimum value B_{min,2} and a second maximum value B_{max,2} in the circumferential direction φ over the circumference of the second drilling segment 23-2; the second inner distance B₂(φ, h) varies in the height direction h and decreases in the direction of the second upper side 32-2 of the second drilling segment 23-2. The second inner distance B₂(φ, h) has a further second maximum value B_{max,2}, wherein the second absolute minimum value B_{min,2} is arranged between the two second maximum values B_{max,2} in the circumferential direction φ. The second inner distance B₂(φ, h) follows a strictly monotonic profile in the region of the second absolute minimum value B_{min,2} in the plane 26 perpendicular to the longitudinal axis 24.

The distribution of the second maximum values B_{max, 2} and of the second absolute minimum value B_{min, 2} over the circumference of the second drilling segment 23-2, the strictly monotonic profile of the second inner distance B₂(φ, h) in the region of the second absolute minimum value B_{min, 2} and the variation of the second inner distance B₂(φ, h) in the height direction h allow the production of a second drilling segment 23-2 with a small contact surface with respect to the drill core 35. The second drilling segment 23-2 can be in contact with the drill core 35 only in the region of the second absolute minimum value B_{min,2}, with all remaining regions of the second inner lateral surface 28-2 having a gap with respect to the drill core 35.

In the exemplary embodiment, the first drilling segment 23-1 and second drilling segment 23-2 are of identical design within production tolerances and are offset from one another by about 180° in the circumferential direction φ. With an offset of about 180°, the first absolute minimum value B_{min,1} and second absolute minimum value B_{min,2} are opposite one another in the circumferential direction φ and lead to a mirror-symmetrical design of the drill bit 20. The mirror-symmetrical design allows vibrations of the drill bit 20 to be reduced during the drilling operation and the running smoothness of the drill bit 20 to be improved.

The first inner cone 34-1 has a first base surface which differs from a circular shape and which is formed as a first elliptical shape in the exemplary embodiment, and the second inner cone 34-2 has a second base surface which differs from a circular shape and which is formed as a second elliptical shape in the exemplary embodiment. The first drilling segment 23-1 and second drilling segment 23-2 are arranged in such a way that the first absolute minimum value B_{min,1} of the first drilling segment 23-1 and the second absolute minimum value B_{min,2} of the second drilling segment 23-2 form the short semiaxis of the elliptical shape.

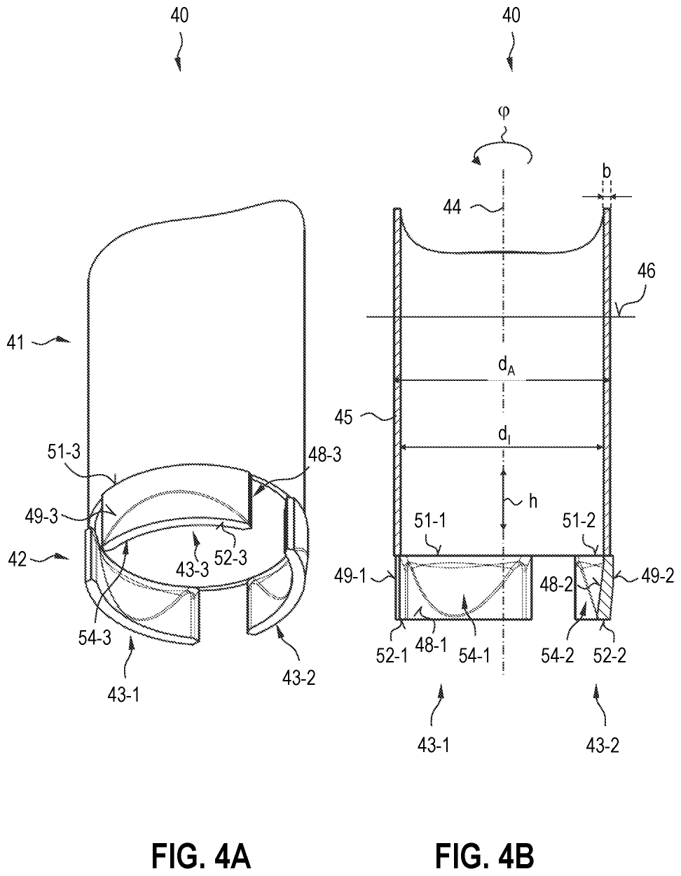

FIGS. 4A, B show a second embodiment of a drill bit 40 according to the invention which has a drilling shaft 41 and a cutting portion 42 having a first drilling segment 43-1, a second drilling segment 43-2 and a third drilling segment 43-3. In this case, FIG. 4A shows the drill bit 40 in a three-dimensional view and FIG. 4B shows the drill bit 40 in a longitudinal section parallel to the longitudinal axis 44 of the drilling shaft 41.

The drilling shaft 41 comprises a cylinder 45 which, in a plane 46 perpendicular to the cylinder axis, which defines the longitudinal axis 44 of the drilling shaft 41, has an outside diameter d_{A}, an inside diameter d_{I} and a shaft width b. In the exemplary embodiment, the inside diameter d_{I}, the outside diameter d_{A} and the shaft width b are constant both in a circumferential direction φ and in a height direction h. Alternatively, the inside diameter, the outside diameter and/or the shaft width can vary in the circumferential direction φ and/or the height direction h.

The first drilling segment 43-1 comprises a first inner lateral surface 48-1, a first outer lateral surface 49-1, a first underside 51-1 and a first upper side 52-2, the second drilling segment 43-2 comprises a second inner lateral surface 48-2, a second outer lateral surface 49-2, a second underside 51-2 and a second upper side 52-2, and the third drilling segment 43-3 comprises a third inner lateral surface 48-3, a third outer lateral surface 49-3, a third underside 51-3 and a third upper side 52-3. Here, the first underside 51-1 of the first drilling segment 43-1, the second underside 51-2 of the second drilling segment 43-2 and the third underside 51-3 of the third drilling segment 43-3 are fastened to an end face of the drilling shaft 41.

The first inner lateral surface 48-1 is formed as a portion of a first inner cone 54-1 which tapers in the direction of the first upper side 52-1 of the first drilling segment 43-1, the second inner lateral surface 48-2 is formed as a portion of a second inner cone 54-2 which tapers in the direction of the second upper side 52-2 of the second drilling segment 43-2, and the third inner lateral surface 48-3 is formed as a portion of a third inner cone 54-3 which tapers in the direction of the third upper side 52-3 of the second drilling segment 43-3.

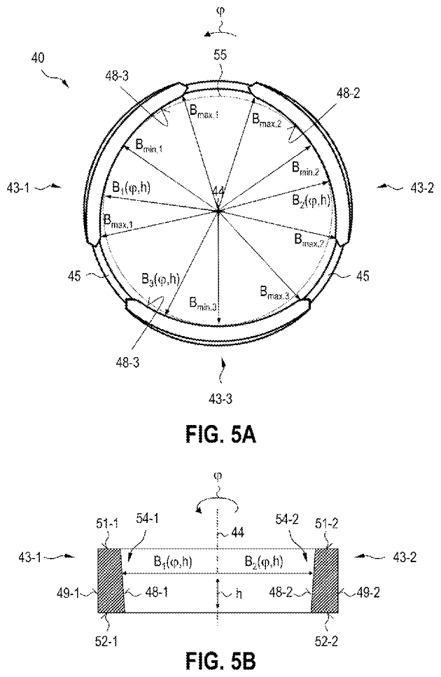

FIGS. 5A, B show the drill bit 40 according to the invention of FIG. 4A in a view of the upper side of the drilling segments 43-1, 43-2, 43-3 (FIG. 5A) and the drilling segments 43-1, 43-2 in a longitudinal section parallel to the longitudinal axis 44 of the drilling shaft 41 (FIG. 5B).

The first inner lateral surface 48-1 has, in the plane 46 perpendicular to the longitudinal axis 44, a first inner distance B₁(φ, h) from the longitudinal axis 44. Here, the first inner distance B₁(φ, h) defines a first mathematical function which describes the profile of the first inner distance over the circumference and the height of the first drilling segment 43-1.

The first inner distance B₁(φ, h) varies between a first minimum value B_{min,1} and a first maximum value B_{max,1} in the circumferential direction φ over the circumference of the first drilling segment 43-1; the first inner distance B₁(φ, h) varies in the height direction h and decreases in the direction of the first upper side 52-1 of the first drilling segment 43-1. The first inner distance B₁(φ, h) has a further first maximum value B_{max,1}, wherein the first absolute minimum value B_{min,1} is arranged between the two first maximum values in the circumferential direction φ. The first inner distance B₁(φ, h) follows a strictly monotonic profile in the region of the first absolute minimum value B_{min,1} in the plane 46 perpendicular to the longitudinal axis 44.

The distribution of the first maximum values B_{max,1} and of the first absolute minimum value B_{min,1} over the circumference of the first drilling segment 43-1, the strictly monotonic profile of the first inner distance B₁(φ, h) in the region of the first absolute minimum value B_{min,1} and the variation of the first inner distance B₁(φ, h) in the height direction h allow the production of a first drilling segment 43-1 with a small contact surface with respect to the drill core 55. The first drilling segment 43-1 can be in contact with the drill core 55 only in the region of the first absolute minimum value B_{min,1}, with all remaining regions of the first inner lateral surface 43-1 having a gap with respect to the drill core 55.

The second inner lateral surface 48-2 has, in the plane 46 perpendicular to the longitudinal axis 44, a second inner distance B₂(φ, h) from the longitudinal axis 44. Here, the second inner distance B₂(φ, h) defines a second mathematical function which describes the profile of the second inner distance over the circumference and the height of the second drilling segment 43-2.

The second inner distance B₂(φ, h) varies between a second minimum value B_{min,2} and a second maximum value B_{max,2} in the circumferential direction φ over the circumference of the second drilling segment 43-2; the second inner distance B₂(φ, h) varies in the height direction h and decreases in the direction of the second upper side 52-2 of the second drilling segment 43-2. The second inner distance B₂(φ, h) has a further second maximum value B_{max,2}, wherein the second absolute minimum value B_{min,2} is arranged between the two second maximum values in the circumferential direction φ. The second inner distance B₂(φ, h) follows a strictly monotonic profile in the region of the second absolute minimum value B_{min,2} in the plane 46 perpendicular to the longitudinal axis 44.

The distribution of the second maximum values B_{max, 2} and of the second absolute minimum value B_{min, 2} over the circumference of the second drilling segment 43-2, the strictly monotonic profile of the second inner distance B₂(φ, h) in the region of the second absolute minimum value B_{min, 2} and the variation of the second inner distance B₂(φ, h) in the height direction h allow the production of a second drilling segment 43-2 with a small contact surface with respect to the drill core 55. The second drilling segment 43-2 can be in contact with the drill core 55 only in the region of the second absolute minimum value B_{min,2}, with all remaining regions of the second inner lateral surface 48-2 having a gap with respect to the drill core 55.

The third inner lateral surface 48-3 has, in the plane 46 perpendicular to the longitudinal axis 44, a third inner distance B₃(φ, h) from the longitudinal axis 44. Here, the third inner distance B₃(φ, h) defines a third mathematical function which describes the profile of the third inner distance over the circumference and the height of the third drilling segment 43-3.

The third inner distance B₃(φ, h) varies between a third minimum value B_{min,3} and a third maximum value B_{max,3} in the circumferential direction φ over the circumference of the third drilling segment 43-3; the third inner distance B₃(φ, h) varies in the height direction h and decreases in the direction of the third upper side 52-3 of the third drilling segment 43-3. The third inner distance B₃(φ, h) has a further third maximum value B_{max,3}, wherein the third absolute minimum value B_{min,3} is arranged between the two third maximum values B_{max,3} in the circumferential direction φ. The third inner distance B₃(φ, h) follows a strictly monotonic profile in the region of the third absolute minimum value B_{min,3} in the plane 46 perpendicular to the longitudinal axis 44.

The distribution of the third maximum values B_{max,3} and of the third absolute minimum value B_{min,3} over the circumference of the third drilling segment 43-3, the strictly monotonic profile of the third inner distance B₃(φ, h) in the region of the third absolute minimum value B_{min,3} and the variation of the third inner distance B₃(φ, h) in the height direction h allow the production of a third drilling segment 43-3 with a small contact surface with respect to the drill core 55. The third drilling segment 43-3 can be in contact with the drill core 55 only in the region of the third absolute minimum value B_{min,3}, with all remaining regions of the third inner lateral surface 48-3 having a gap with respect to the drill core 55.

In the exemplary embodiment, the first drilling segment 43-1, the second drilling segment 43-2 and the third drilling segment 43-1 are of identical design within production tolerances and are offset from one another by about 120° in the circumferential direction φ. With an offset of about 120°, the first absolute minimum value B_{min,1}, the second absolute minimum value B_{min,2} and the third absolute minimum value B_{min,3} are equally distributed in the circumferential direction φ and lead to a mirror-symmetrical design of the drill bit 40. The mirror-symmetrical design allows vibrations of the drill bit 40 to be reduced during the drilling operation and the running smoothness of the drill bit 40 to be improved.

The first inner cone 54-1 has a first base surface which differs from a circular shape and can be formed as a first elliptical shape, the second inner cone 54-2 has a second base surface which differs from a circular shape and can be formed as a second elliptical shape, and the third inner cone 54-3 has a third base surface which differs from a circular shape and can be formed as a third elliptical shape.

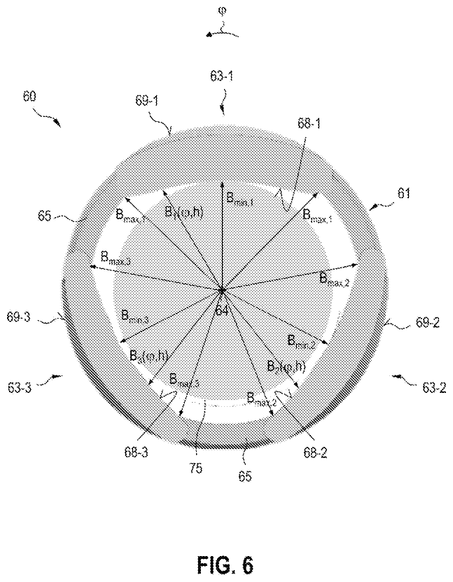

FIG. 6 shows a third embodiment of a drill bit 60 according to the invention which has a drilling shaft 61 and a cutting portion having a first drilling segment 63-1, a second drilling segment 63-2 and a third drilling segment 63-3, in a view of the upper side of the drilling segments 63-1, 63-2, 63-3.

The drill bit 60 differs from the drill bit 20 of FIG. 2A and the drill bit 40 of FIG. 4A in that the second and third drilling segment 63-2, 63-3 differ from the first drilling segment 63-1. The drilling shaft 61 is designed analogously to the drilling shaft 21 of the drill bit 20 and to the drilling shaft 41 of the drill bit 40. The drilling shaft 61 comprises a cylinder 65 having a cylinder axis which defines a longitudinal axis 64 of the drilling shaft 61.

The first drilling segment 63-1 comprises a first inner lateral surface 68-1, a first outer lateral surface 69-1, a first underside and a first upper side, the second drilling segment 63-2 comprises a second inner lateral surface 68-2, a second outer lateral surface 69-2, a second underside and a second upper side, and the third drilling segment 63-3 comprises a third inner lateral surface 68-3, a third outer lateral surface 69-3, a third underside and a third upper side. Here, the first underside of the first drilling segment 63-1, the second underside of the second drilling segment 63-2 and the third underside of the third drilling segment 63-3 are fastened to the drilling shaft 61.

The first inner lateral surface 68.1 is, like the first inner lateral surfaces 28-1, 48-1, formed as a portion of a first inner cone which tapers in the direction of the first upper side of the first drilling segment 63-1. The first inner lateral surface 68-1 has, perpendicular to the longitudinal axis 64 of the drilling shaft 61, a first inner distance B₁(φ, h) from the longitudinal axis 64. Here, the first inner distance B₁(φ, h) defines a first mathematical function which describes the profile of the first inner distance over the circumference and the height of the first drilling segment 63-1.

The first inner distance B₁(φ, h) varies between a first minimum value B_{min,1} and a first maximum value B_{max,1} over the circumference of the first drilling segment 63-1. The first inner distance B₁(φ, h) has a further first maximum value B_{max,1}, wherein the first absolute minimum value B_{min,1} is arranged between the two first maximum values in the circumferential direction φ. The first inner distance B₁(φ, h) follows a strictly monotonic profile in the region of the first absolute minimum value B_{min,1} in the plane perpendicular to the longitudinal axis 64.

The second inner lateral surface 68-2 is, like the second inner lateral surfaces 28-2, 48-2, formed as a portion of a second inner cone which tapers in the direction of the second upper side of the second drilling segment 63-2. The second inner lateral surface 68-2 has, perpendicular to the longitudinal axis 64 of the drilling shaft 61, a second inner distance B₂(φ, h) from the longitudinal axis 64. Here, the second inner distance B₂(φ, h) defines a second mathematical function which describes the profile of the second inner distance over the circumference and the height of the second drilling segment 63-2.

The second inner distance B₂(φ, h) varies between a second minimum value B_{min,2} and a second maximum value B_{max,2} over the circumference of the second drilling segment 63-2. The second inner distance B₂(φ, h) has a further second maximum value B_{max,2}, wherein the second absolute minimum value B_{min,2} is arranged between the two second maximum values in the circumferential direction φ. The second inner distance B₂(φ, h) follows a strictly monotonic profile in the region of the second absolute minimum value B_{min,2} in the plane perpendicular to the longitudinal axis 64.

The third inner lateral surface 68-3 is, like the third inner lateral surfaces 28-3, 48-3, formed as a portion of a third inner cone which tapers in the direction of the third upper side of the third drilling segment 63-3. The third inner lateral surface 68-3 has, perpendicular to the longitudinal axis 64 of the drilling shaft 61, a third inner distance B₃(φ, h) from the longitudinal axis 64. Here, the third inner distance B₃(φ, h) defines a third mathematical function which describes the profile of the third inner distance over the circumference and the height of the third drilling segment 63-3.

The third inner distance Ba (φ, h) varies between a third minimum value B_{min,3} and a third maximum value B_{max,3} over the circumference of the third drilling segment 63-3. The third inner distance B₃(φ, h) has a further third maximum value B_{max,3}, wherein the third absolute minimum value B_{min,3} is arranged between the two third maximum values in the circumferential direction φ. The third inner distance B₃(φ, h) follows a strictly monotonic profile in the region of the third absolute minimum value B_{min,3} in the plane perpendicular to the longitudinal axis 64.

In the exemplary embodiment of FIG. 6, the second and third drilling segment 63-2, 63-3 are of identical design and differ from the first drilling segment 63-1 in that the first absolute minimum value B_{min,1} is less than the second and third absolute minimum value B_{min,2}, B_{min,3}. This means that the second and third drilling segment 63-2, 63-3 do not have a contact surface with respect to the drill core 75. The contact surface between the drilling segments 63-1, 63-2, 63-3 and the drill core 75 is limited to the region of the first absolute minimum value B_{min, 1}.

1-14. (canceled)

15. A drill bit comprising:
a drilling shaft having a cylinder with a longitudinal axis, wherein the cylinder has, in a plane perpendicular to the longitudinal axis, an outside diameter, an inside diameter and a shaft width, and
a plurality of drilling segments spaced apart from one another in a circumferential direction and fastened by an underside to the drilling shaft, wherein the plurality of drilling segments include a first drilling segment with a first inner lateral surface having a first inner distance from the longitudinal axis perpendicular to the longitudinal axis, and a second drilling segment with a second inner lateral surface having a second inner distance from the longitudinal axis perpendicular to the longitudinal axis,
the first inner lateral surface of the first drilling segment being formed as a portion of a first inner cone tapering in a direction of a first upper side opposite to the underside of the first drilling segment.

16. The drill bit as recited in claim 15 wherein the first inner cone has a first base surface which differs from a circular shape, and the first inner distance varies in the circumferential direction over the circumference of the first drilling segment.

17. The drill bit as recited in claim 16 wherein the first inner distance varies between a first maximum value and a first minimum value and has precisely one first absolute minimum value over the circumference of the first drilling segment.

18. The drill bit as recited in claim 15 wherein the second inner lateral surface of the second drilling segment is formed as a portion of a second inner cone which tapers in the direction of a second upper side opposite to the underside of the second drilling segment.

19. The drill bit as recited in claim 18 wherein the second inner cone has a second base surface which differs from a circular shape, and the second inner distance varies in the circumferential direction over the circumference of the second drilling segment.

20. The drill bit as recited in claim 19 wherein the second inner distance varies between a second maximum value and a second minimum value and has precisely one second absolute minimum value over the circumference of the second drilling segment.

21. The drill bit as recited in claim 15 wherein the first drilling segment and second drilling segment are of identical design.

22. The drill bit as recited in claim 21 wherein the first drilling segment and second drilling segment are arranged in an equally distributed manner in the circumferential direction.

23. The drill bit as recited in claim 15 wherein, in addition to the first drilling segment and second drilling segment, the plurality of drilling segments include a third drilling segment with a third inner lateral surface having a third inner distance from the longitudinal axis perpendicular to the longitudinal axis.

24. The drill bit as recited in claim 23 wherein the third inner lateral surface of the third drilling segment is formed as a portion of a third inner cone tapering in the direction of a third upper side opposite to the underside of the third drilling segment.

25. The drill bit as recited in claim 24 wherein the third inner cone has a third base surface differing from a circular shape, and the third inner distance varies in the circumferential direction over the circumference of the third drilling segment.

26. The drill bit as recited in claim 25 wherein the third inner distance varies between a third maximum value and a third minimum value and has precisely one third absolute minimum value over the circumference of the third drilling segment.

27. The drill bit as recited in claim 23 wherein the first drilling segment, second drilling segment and third drilling segment are of identical design.

28. The drill bit as recited in claim 27 wherein the first drilling segment, second drilling segment and third drilling segment are arranged in an equally distributed manner in the circumferential direction.
